(19) United States
(12) Patent Application Publication
(10) Pub. No.: US 2011/0264470 A1
(43) Pub. Date: Oct. 27, 2011

(54) Rule-Based Financial Products

(75) Inventor: Paul C. Miller, Glencoe, IL (US)

(73) Assignee: Enservio, Inc.

(21) Appl. No.: 12/764,610

(22) Filed: Apr. 21, 2010

(51) Int. Cl. G06Q 40/00; G06Q 10/00

(52) U.S. Cl. 705/4; 705/30; 705/41; 705/44

(57) ABSTRACT

Stored-value cards are governed by a set of rules that limit purchases to approved replacement items and/or recurring living expenses based on losses actually incurred by the insured within certain categories and according to time-based, insurer-specified spending limits. These limits can be altered in response to changed circumstances or the needs (or behavior) of the insured. A system for implementing various aspects of this technique includes an event-detection module for detecting a purchase event initiated by an individual associated with the financial account. A rules engine applies a rule set against the purchase event to determine if the potential purchase complies with the rule set. The rule set includes both a category-based rule and a time-based rule, such that a maximum amount may be spent on purchases during a particular time period (e.g., a month) within a particular category (e.g., food, housing, transportation, medical care, etc.). The system further includes a messaging module for approving the purchase if it complies with the rule set.

### TECHNICAL FIELD

Embodiments of the invention relate generally to systems and methods for reimbursing insured individuals for losses, and, more particularly, to systems, methods, and financial-services products that may be used to facilitate the purchase of approved replacement items or to spend funds according to spending categorization or time-based rules.

### BACKGROUND OF THE INVENTION

Consumers and businesses often purchase insurance to cover losses to property ranging from personal items to buildings and infrastructure. Coverage can vary widely. Home insurance, for example, may cover more than just a physical structure. A typical homeowner's policy usually covers the loss of items within the home, such as furniture, clothing, electronics, appliances, artwork, jewelry, and other items. Renter's insurance covers many of the same items, excluding fixtures and the like. Insurance may also, in some cases, cover additional living expenses, such as temporary housing, food and restaurant expenses, dry cleaning, transportation, etc.

When a loss occurs, conventional practice is for the insurance company (the “issuer”) to assess the damage, estimate the loss, and provide a “live” check to the insured. In some instances, the policy also covers recurring incidental expenses, such as hotel bills, food, transportation, and the like. While the issuer of the policy may control the amount of the check, it cannot determine how the insured will actually use the money, either initially or over time. Moreover, issuing live checks is expensive, and vulnerable to loss and fraud.

The Commercial and financial industries have, over the past few years, actively embraced the “stored-value card” or “debit card” concept. These cards provide the holder with a pre-defined spending limit based on either a bank-account balance or a set amount associated with the card. The cardholder may use the card at participating establishments to purchase goods and services until the funds associated with the card are exhausted. Like credit cards, debit cards and some stored-value cards require authorization or activation by in individual cardholder prior to an initial use, and, in some cases, the use of a personal identification number (“PIN”) to make purchases with the card.

While less expensive and more secure than live checks, stored-value cards can still be used freely—i.e., with no restriction on what is purchased, regardless of the nature of the loss. This limits the ability of the issuer to tailor a spending program to a particular loss, and to exhibit flexibility in terms of what is purchased. Particularly in cases where the issuer provides ongoing funding for living expenses (e.g., as the insured's house is being repaired), the issuer may wish to provide the insured with a periodic (typically weekly) budget and restrict expenditures to legitimate items. In addition, the issuer may wish to accord budgetary flexibility on some items (allowing the insured to “borrow” from the next period's budget for essentials such as food, for example) but not on others.

What is needed is a system and associated techniques and products that allow for item-level monitoring and flexibility, particularly in connection with time-based or recurring expenses.

### BRIEF SUMMARY OF THE INVENTION

Embodiments of the present invention permit insurance companies to issue stored-value cards (or other means to access a financial account) governed by a set of rules that limit purchases to approved replacement items and/or recurring living expenses based on losses actually incurred by the insured within certain categories and according to time-based, insurer-specified spending limits. In various embodiments, these limits can be altered by the insurer in response to changed circumstances or the needs (or behavior) of the insured.

In one aspect of the invention, a system that operates in conjunction with a financial account is provided for permitting usage of the funds associated with the financial account to purchase goods and/or services. The system includes an event-detection module for detecting a purchase event initiated by an individual associated with the financial account. A rules engine applies a rule set against the purchase event to determine if the potential purchase complies with the rule set. The rule set includes both a category-based rule and a time-based rule, such that a maximum amount may be spent on purchases during a particular time period (e.g., a month) within a particular category (e.g., food, housing, transportation, medical care, etc.). The system further includes a messaging module for approving the purchase if it complies with the rule set.

In some instances, the financial account is established in response to an insurance claim. The financial account may represent an amount of money available to the owner or owners of the insurance policy on which the claim was filed. In some cases, the rule set associated with the financial account limits purchases during the specified time period to amounts below a predefined limit for the category. However, in some embodiments, an exception may be made wherein a purchase above the limit is allowed (up to an alternative limit, for example), but the amount over the allowed amount is deducted from an amount allowed for a subsequent time period or from a general settlement amount issued to cover contents and/or structural damage. The system may also include a data-storage component for storing rule sets associated with financial accounts. In some cases, the rule set may also limit what can be purchased (e.g., limiting purchases to particular items) and/or where they may be purchased. For example, the rules may specify that the individual(s) associated with the financial accounts may only purchase specified items from particular businesses.

In another aspect of the invention, a device associated with a financial account is provided. The device may include a data-storage medium for storing computer-readable program code governing the authorization and use of the device. In some instances, the device is a stored-value card, a debit card or a credit card. In other cases, the device is a virtual device, such as an on-line credit, gift certificate, or balance made available to its users. The program code may include instructions for implementing rules governing use of the device, such as restrictions on goods or services to which the money in the account may be applied, how much may be spent during a particular time period within a particular category of goods and services, who may spend it, a date by which the money must be spent, and/or establishments where the money is spent.

In yet another aspect, a computer-implemented method is provided for authorizing and governing the use of funds associated with a financial account. The computer-implemented method comprises receiving a purchase event identifying a purchase by an individual associated with the financial account, and a rule set is applied against the purchase event to determine if the purchase complies with the rule set. The rule set includes both a category-based component and a time-based component, such that a maximum amount may be spent on purchases during a particular time period (e.g., a month) within a particular category (e.g., food, housing, transportation, medical care, etc.). The purchase is approved if it complies with both the time and category-based rules.

### BRIEF DESCRIPTION OF THE DRAWINGS

The present invention is described in detail below with reference to the attached drawing, wherein:

FIG. 1 is a flow chart illustrating the operation of a system in accordance with various embodiments of the invention; and

FIG. 2 is a block diagram illustrating the components of a system in accordance with various embodiments of the invention.

### DETAILED DESCRIPTION OF PREFERRED EMBODIMENTS

When a consumer or business suffers a loss of property due to fire, theft or other event, an insurance claim may be filed to cover the replacement cost associated with the loss. Often, the claim arises from an insurance policy owned either by an entity (e.g., a corporation) or a couple (e.g., a husband and wife). In either case, common practice is to issue a live check in the amount deemed appropriate given the loss. For example, if a fire consumes clothing, appliances and household items in a couple's home, the couple can file a claim against their homeowner's policy requesting reimbursement for the lost items. Once an amount is agreed upon, the insurer issues a check.

In some instances, proceeds from an insurance claim may be used to for recurring living expenses such as groceries, housing (e.g., a hotel), transportation, medical expenses, and other daily expenditures. However, the insurance companies may want to put in place rules that govern how the proceeds (or relevant portion thereof) can be spent during any one time period or on certain items. For example, the insurer may have negotiated special rates with a hotel chain, allotting $5,000 per month for a hotel based on these rates and $1,500 per month for restaurant and grocery expenses. With such constraints in place, the insurer can ensure that the insured party uses the proceeds from their claim appropriately.

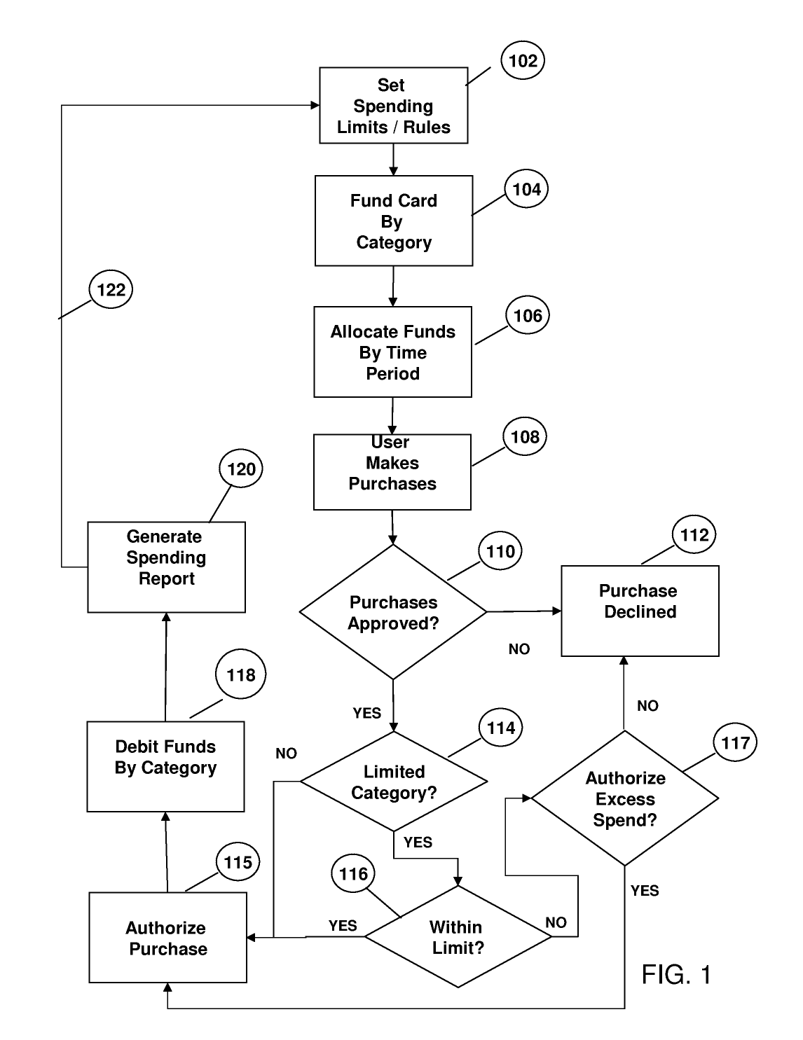

FIG. 1 illustrates the operation of a representative embodiment of the present invention, in which the holder of a stored-value card purchases items using funds in a financial account associated with the card. As used herein a “card” may refer to a debit card, a credit card, a gift card, an online stored-value account, or other device (either physical or virtual) that is associated with the financial account. In order to help the cardholder budget her purchases and use the funds to cover basic living expenses, some (or all) of the funds may be subject to certain usage rules. The rules may, for example, determine how much can be spent during a particular time period (e.g., monthly) and/or for a particular category of good or service. In such cases, the card may be identified as a “temporary living expense card” and its use may be limited to such purchases. In other instances, a general settlement account may be set up with a pool of funds that are available generally, and may be used to augment funds allocated to a particular category, if so approved. In other cases, the rules may dictate that, even if funds are available in a general settlement account, limits on certain living expenses (e.g., food, clothing, housing) may be capped.

As shown in FIG. 1, an insurance claim is filed and a financial account is established on behalf of the claimant(s). The insurer defines a rule set for the account (102) that governs allowable purchases using the account. In some cases, funds are allocated to a particular category (104). For example, if the account is initially funded with $75,000 to cover a year of living expenses, $60,000 may be allocated to “shelter” (e.g., for hotel bills) and $15,000 for food. Other categories such as transportation (to pay for a rental car, for example), medical expenses, and clothing may be set up. Further, these funds may be allocated over a series of time periods (106) to assist the insured parties with budgeting. Using the example above, the $60,000 allocated to shelter may be divided into twelve monthly tranches of $5,000 each. As a result, requests for payment authorization for purchases that, in total, exceed $5,000 in any one month may be denied or, in some cases, subject to an additional approval process.

Once set up, the insured party is given access to the financial account and uses the card to purchase goods and services (108). Information describing the purchase (type of goods being purchased, amount, date, establishment at which goods are being purchased or lodging obtained, category of goods or services, etc.) is analyzed and a decision (110) is made as to whether to approve the purchase or not. If, for example, the proposed purchase is a hotel bill for $3,000 but only $2,500 remains in the account, the purchase may be declined (112). If the purchase is approved but attributed to a category having specific spending limits, a second rule check is performed (114) to determine if the particular purchase is governed by the rules. Using the example above, the $5,000 monthly stipend may be applied against a series of charges to hotels, and the purchases denied if they exceed $5,000 for a particular month. If the purchase does not fall within a limited category, the purchase is authorized (115). If the purchases falls within a limited category, a check is made to determine of the purchase is within the specified limits (116). If it is within the limit, the purchase is authorized (15).

In some instances, spending in excess of the funds remaining on the card (or usable during the current spending period) may be allowed. For example, the base rule may limit monthly spend on food to $1,000, but allow a “buffer” or excess spend of $200 per month. The excess may be quantified as an absolute amount or as a percentage of the overall monthly budget (i.e., 10%). In such cases, a determination whether to allow the excess spend is made (117). If so, the purchase is authorized (115), the funds are debited from the account (either a general account, another category, or the same category but from a future time period) and allocated to the appropriate category (118). If the category has no limits, the funds are debits from the account without any category allocation.

In some cases, the excess amount may be deducted from a subsequent period's allocated funds. For example, an approved excess spend of $200 in one month may be “deducted” from the budgeted amount for the following month, leaving, in the example above, $800 budgeted for food. In some cases, the excess spend may be spread across some or all of the remaining time periods (e.g., $40/month for five months) to lessen the impact on any one month. In other examples, the allocation of funds may be unequal across time periods to allow for seasonal adjustments (e.g., holidays, summer vacations, etc.). One or more spending reports (120) may be generated and provided to the cardholder and/or the financial institution managing the account.

In some cases, the spending reports may be used as feedback (122) to update the rule set. For example, if the cardholder routinely spends more money in a particular category than originally allocated to that category, the rule set may be updated such that the spending limit for that category may be increased. Likewise, if a cardholder rarely uses the funds (e.g., funds allocated to a hotel are not used because she is staying with a relative) the funds can be reallocated to other categories.

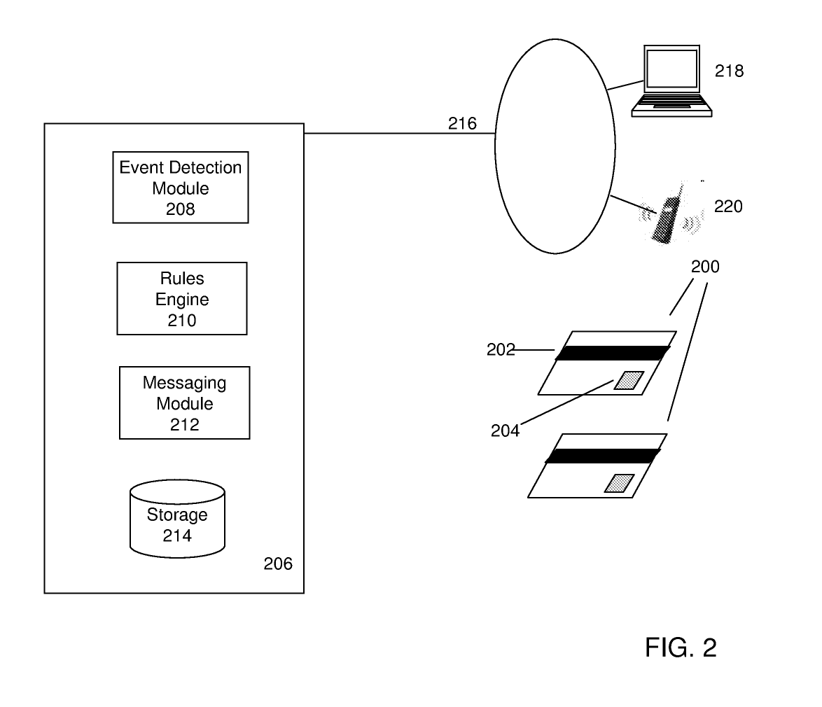

FIG. 2 illustrates a system for implementing the techniques described above. A card or cards 200 may have stored thereon computer-readable instructions and/or data governing usage restrictions, by means, e.g., of a magnetic strip 222, an embedded chip or memory device 244, or both. More typically, however, the card 200 may include only identifying information, with purchases approved and the rules enforced from a central location, as described below. The card 200 may also include components for providing or processing either account, identity, payment, health, transactional, or other information and communicating with central processing units or computers operated by the providers of services, such as credit card institutions, banks, health care providers, universities, retailers, wholesalers or other providers of goods or services employers, or membership organizations. Card features may also enable the card to communicate with or be accessed by other devices, including those used by retailers (e.g., point-of-sale computers), and personal computers used in other business applications or at home (for example, a personal computer having a built-in or attached card reader).

A central computing device 206 processes purchase transactions related to the use of the card 20, and includes an event-detection module 208, a rules engine 210, a messaging module 212, and in some instances one or more data-storage devices 214 (e.g., hard disks). The data-storage devices 214 and/or central computing device 206 may store financial information pertaining to the account related to the card 200 as well as instructions for activating and authorizing use of the card. The central computer device 206 may send and receive communications regarding card usage over a network 216, such as the Internet or, in some cases, a private network. Cardholders may use one or more computing and/or communication devices (e.g., a computer 218 or a hand-held device 220) to send and receive account information and authorization messages from the central computing device 206.

For example, the central computing device 206 receives messages and/or events from cardholders wishing to use the card 200 to purchase goods and services. However, in some implementations, the card 200 may be associated with a financial account having one or more usage restrictions, and in such cases the event-detection module 28 identifies an potential purchase request from a cardholder and the rules engine processes computing instructions that apply the rule set against the purchase request to determine if is an authorized purchase.

The rule set—which may be organized in a database containing rule sets for multiple cardholders, as described below—may include category and time-based restrictions as described above, and/or may also implement guidelines or incentives (e.g., using the card at a particular retailer allows the cardholder to receive special discounts and other offers). In other cases the rules may dictate that the cardholders use the cards at specific locations (either physical or web-based) and/or for specific items. This may be the case where, for example, the card is issued based on an insurance claim against particular property such as electronics and clothing lost in a house fire. In such instances, the card issuer or the insurance company may operate a retail portal that allows cardholders to shop for replacement items directly, or in some cases via referrals to other participating retailers.

Further, the insurance company may attribute usage rules to the card (and, by extension, the funds in the account associated with the card) that limit what the cardholders can purchase, where they can make specific types of purchases, price restrictions on certain goods, and/or a deadline (e.g., the end of the current recurring time period) by which certain (or all) purchases must be made. These rules are stored in the data-storage device 214 and implemented by the rules engine 210 each time the card 200 is used—i.e., each time event-detection module 208 detects an attempt to make a purchase. For example, with a master set of rules stored in a database, rules engine 210 implements only those rules applicable to a particular cardholder. Each cardholder's database record may contain pointers to the rules associated with that cardholder, along with arguments or values (particular types of items, allowed retailers, spending limits, etc.) for the parameters called for in the rules. These may be modified centrally as appropriate, and the specified rules in their current form, with the current parameter values, are invoked for each cardholder whenever he uses the card.

For example, a couple who recently suffered a loss due to a fire in their home may need to purchase new furniture, new clothing, new appliances, new electronics, and other household goods to replace those lost or damaged in the fire, as well as monthly living expenses such as hotel bills, groceries, etc. Using the technique and system described above, the card is associated with a financial account funded by their insurance company. The insurance company may instruct the card issuer that only a certain amount may be charged on the card per month related to food purchases. Alternatively, the card issuer may transmit purchase information (cardholder identity and item to be purchased, for example) to a third party server, and allow the purchase to go through only upon receipt of approval once received from the insurance company.

In some implementations, the merchandise available to the cardholder may be pre-specified by the insurer funding the financial account to which the card is related. Such a restriction may be used to ensure that the cardholders use the funds from their claim to purchase actual replacement items, and, in some cases, may facilitate the collection of referral fees from the retailers in exchange for channeling customers to their establishment. In certain instances, the merchandise available to a particular cardholder may be limited only to the exact items (or approved alternatives) claimed as lost pursuant to their policy. All of these restrictions may be implemented in rules, as described above.

In some cases, a third-party may work with one or more online retailers (e.g., Amazon.com) and/or brick-and-mortar retailers with an extensive online presence (e.g., Sears, Target, etc.) to build cardholder-specific portals at which on the approved merchandise is available and, in some cases, use of the activated cards may be limited—by user-specific rules—to purchases from these portals. In other cases, the cards may be authorized for use at any retail establishment without any restrictions whatsoever. The third parties may contract with specific insurers, card issuers or both to provide these services.

The components of the central computing device 26 may be implemented by computer-executable instructions, such as program modules, being executed by a computer. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The central computing device 206 may include a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used in accordance with the various embodiments of the invention. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 206 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network 216 may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

While particular embodiments of the invention have been illustrated and described in detail herein, it should be understood that various changes and modifications might be made to the invention without departing from the scope and intent of the invention. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A system, operating in conjunction with a financial account, for governing usage of funds associated with the financial account, the system comprising:
an event-detection module for detecting a purchase event initiated by an individual associated with the financial account;
a rules engine for applying a rule set against the purchase event and determining whether the purchase complies with the rule set, the rule set comprising (i) at least one category-based rule governing items allowed to be purchased by the individual and (ii) at least one time-based rule governing an amount the individual may spend within the at least one category during a specified time period; and
a messaging component for signaling approval if the potential purchase complies with the category and time-based rules.

2. The system of claim 1 wherein the time-based rule limits purchases during the specified time period to amounts below a predefined limit within the at least one category.

3. The system of claim 2 wherein the time-based rule further comprises an exception that permits the individual to make purchases within an exception category above the predefined limit up to an alternative limit.

4. The system of claim 3 wherein the difference between the alternative limit and the predefined limit is deducted from the predefined limit for subsequent time periods for the exception category.

5. The system of claim 1 wherein the at least one category comprises at least one of living expenses, food expenses, transportation expenses, and medical expenses.

6. The system of claim 1 wherein the time-based rule comprises a monthly maximum per category.

7. The system of claim 1 further comprising a data-storage component for the rule set associated with the financial account.

8. The system of claim 1 wherein the rule set limits use of funds in the financial account to purchases of items within the at least one category.

9. The system of claim 8 wherein the rule set limits use of funds in the financial account to purchases of specified items.

10. The system of claim 1 wherein the specified items comprise replacement items for items claimed on an insurance claim.

11. The system of claim 8 wherein the rule set limits use of funds in the financial account to purchases from specific businesses.

12. The system of claim 1 wherein the rule set is modifiable on an ongoing basis.

13. A computer-implemented method for governing usage of funds associated with a financial account, the method comprising:
receiving a purchase event identifying a potential purchase by an individual associated with the financial account;
applying a rule set against the purchase event to determine whether the purchase complies with the rule set, the rule set comprising (i) at least one category-based rule governing items allowed to be purchased by the individual and (ii) at least one time-based rule governing an amount the individual may spend within the at least one category during a specified time period; and
approving the purchase if it complies with the category and time-based rules.

14. The method of claim 13 wherein the time-based rule limits purchases during the specified time period to amounts below a predefined limit within the at least one category.

15. The method of claim 14 wherein the time-based rule further comprises an exception that permits the individual to make purchases in an exception category above the predefined limit up to an alternative limit.

16. The method of claim 15 wherein the difference between the alternative limit and the predefined limit is deducted from the predefined limit for subsequent time periods for the exception category.

17. The method of claim 13 wherein the at least one category comprises at least one of living expenses, food expenses, transportation expenses, and medical expenses.

18. The method of claim 13 wherein the time-based rule comprises a monthly maximum per category.

19. The method of claim 13 wherein the rule set limits use of funds in the financial account to purchases of items within the at least one category.

20. The method of claim 1 wherein the rule set limits use of funds in the financial account to purchases of specified items.

21. The method of claim 20 wherein the specified items comprise replacement items for items claimed on an insurance claim.

22. The system of claim 8 wherein the rule set limits use of funds in the financial account to purchases from specific businesses.

23. A device associated with a financial account and used to access funds within the account, the device comprising a data-storage medium for storing computer-readable program code implementing a rule set governing use of the device, wherein the rule set comprises (i) at least one category-based rule governing items allowed to be purchased using the device and (ii) at least one time-based rule governing an amount spent within the at least one category during a specified time period using the device.
